(19) United States
(12) Patent Application Publication
(10) Pub. No.: US 2017/0079221 A1
(43) Pub. Date: Mar. 23, 2017

(54) DRIP IRRIGATION MICROTUBE BRACKET

(71) Applicant: Frederick R. Adams, Healdsburg, CA (US)

(72) Inventor: Frederick R. Adams, Healdsburg, CA (US)

(21) Appl. No.: 15/269,900

(22) Filed: Sep. 19, 2016

Related U.S. Application Data
(60) Provisional application No. 62/220,883, filed on Sep. 18, 2015.

(51) Int. Cl. A01G 25/02; B05B 1/02; F16L 3/04

(52) U.S. Cl. CPC A01G 25/026; F16L 3/04; B05B 1/02

(57) ABSTRACT

A bracket for hanging drip irrigation system water supply tubing and micro-tubing having a wire hanger portion for attachment to a drip irrigation system suspension wire; a micro-irrigation tube hanging portion adapted for releasably capturing and securing micro-irrigation tubing in fluid communication; and a water supply tube portion disposed between said wire hanger portion and said micro-irrigation tube hanging portion, said water supply tube portion for releasably and slidingly clamping onto a drip irrigation water supply tube.

### CROSS REFERENCES TO RELATED APPLICATIONS

The present application claims the benefit of U.S. Provisional Patent Application Ser. No. 62/220,883, filed Sep. 18, 2015 (Sep. 18, 2015).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

Field of the Invention

The present invention relates generally to irrigation systems, and more particularly to drip irrigation systems, and still more particularly to a drip irrigation system microtube bracket for suspending micro-irrigation tubing from emitters above a root zone to be irrigated.

Background Discussion

As of this writing, September 2015, 30% of the contiguous United States is suffering drought conditions. According to the NOAA, California, Nevada, Oregon, Washington, and Alaska have had their hottest years on record. The Western United States is parched, and climate models available at the time of this writing suggest that the region will suffer a prolonged and persistent drought in the latter half of the 21^{st} century. Indeed, the term “megadrought” has been applied to the predicted conditions. Agriculture will be severely affected, and the agricultural industries and government must therefore be responsive and creative in handling and minimizing the adverse impacts. This is particularly true with respect to water management It is no exaggeration to suggest that the moment presents an existential crisis for settlements in the West and fundamentally tests our technical ingenuity, moral resolve, and the social compact.

At the level of regional politics and legislation, at least in California, water use laws and regulations are now increasingly implemented and, where not implemented, increasingly under consideration. Groundwater monitoring and regulation is on the horizon. Even so, if the climate prediction models are even remotely accurate, it is difficult to conceive of a regulatory response that will be sufficient to ensure adequate water for residents and businesses. While this problem is particularly acute in California, the trend seems likely apply to the American West generally. Accordingly, small contributions, additive, will have to come from every direction.

At both small and large scales drip irrigation can make an important contribution to water conservation. Yet, while drip systems are more efficient than other kinds, such as flood, furrow, or overhead, even drip systems suffer from unnecessary waste owing to evaporation and hillside runoff Surface drip also encourages shallow roots. A known method to minimize water loss from evaporation and runoff is to provide depressions immediately underneath the drip emitters in a drip system. This achieves a not insubstantial measure of water savings, but a portion of the surface nonetheless remains wet, thus encouraging weed growth and a corresponding loss due to evaporation. Subsurface irrigation is more efficient than surface drip, but it has its own attendant problems, such as increased emitter clogging, root intrusion, and inaccessibility for inspection and maintenance.

### BRIEF SUMMARY OF THE INVENTION

The drip irrigation microtube bracket (“drip clip”) described herein addresses the foregoing problems from a slightly different perspective. Two specially designed parts have been designed to direct water from the emitter to either a depression in the ground, or preferably a length of perforated pipe or other specific device to direct water subsurface and placed vertically in the ground. The water is directed subsurface through the length of pipe.

The apparatus described herein achieves its objectives by using a micro-irrigation tube (“spaghetti tube”) drip clip, which suspends the spaghetti tubing either connected to distribution tubing with an emitter or having a drip emitter on terminal end above the perforated pipe disposed vertically in the soil surrounding a plant main trunk. The drip clip is secured on a trellis wire, and in turn one or two spaghetti tubes is suspended from the drip clip such that the terminal end of the spaghetti tubes (i.e., the water source) can be moved laterally along the wire to different locations.

In its implementation, a hole is drilled in the ground near the trunk of a tree or vine with either an auger, shovel, pressure washer, or other suitable implement, and perforated pipe is then inserted into the hole in a generally vertical orientation. This prevents collapse of the hole and ensures reliably deep delivery of water to the developed and developing root structure.

In another implementation, spaghetti tubing may be suspended immediately within the opening of the perforated pipe using a perforated pipe clip.

Using either method, both of which may be termed “black hole innergation,” water drips into the pipe and fills the exposed hole from the bottom up. This method encourages deeper root growth and makes water availability to the plant less variable with weather fluctuations. Deeper root growth makes plants less susceptible to a number of pathogens that propagate, disperse, and are transmitted to the plant near the surface.

As will be appreciated, as water is deposited directly and relatively deeply into the soil, it is more readily available for root uptake. Depending on soil porosity and percolation rates, as well as the run cycle of the drip system, using the improved micro-irrigation drip clip, surface moisture can be kept to a minimum, which reduces both evaporation and weed growth.

Pipe length is largely dictated by soil composition and texture—compacted and heavy soils may call for a longer length of pipe; more porous sandy and loam soils may call for a shorter piece.

The inventive method allows for soil amendments and fertilizers to be inserted directly into the perforated pipe, which also conserves on materials, which are prevented from loss due to runoff, as well as on the environmental impact of soil treatment migrating to neighboring areas.

In an alternate embodiment, the perforated pipe may be filled with compost, fertilizer, and/or biochar to prevent debris from entering the pipe. Damage to roots when installing the system and drilling holes for the perforated pipe can be minimized by moving the water source away from the plant's main trunk. Then filling the pipe with compost minimizes damage to roots from exposure to air. The compost absorbs water and releases nutrients to the roots. By absorbing water, the compost also retains moisture that might otherwise descend beneath the root zone in very porous soil. Much less fertilizer can be used once dosage is determined.

In hillside vineyards and orchards, the texture of the soil varies dramatically over short distances. Black hole innergation allows irrigation to be customized for each plant in a hillside crop by using varying pipe lengths, emitters of varying output, and amendments. Innergation can be adapted to organic vineyards, reducing labor required for weed control and requiring fewer soil amendments.

The heart of the preferred embodiment is a micro-irrigation (spaghetti) tube drip tube hanger. It bears a superficial resemblance to presently available products, but is distinguishable in several important respects.

The only purpose of known irrigation clips is to suspend a drip tube near the trellis wire. One currently known product grips the drip tube securely but fits loosely on the drip tube support wire. Another present product grips both the drip tube and drip wire securely.

The drip clip grips the trellis wire securely but still allows the drip tube to slide easily through the clip, minimizing the chance of my hanger moving from its' position on the wire. Further, the improved micro-irrigation drip clip described herein grips the two principle sizes of wire conventionally used for drip tube suspension by providing two open circles sized to provide a tight friction fit to grip either size of suspension wire.

Most importantly, the drip clip not only grips the suspension wire tightly, the clip body includes an arcuate opening to accept and loosely grip emitter distribution tubing (OD ranging between 0.620″ to 0.710″) so as to allow it to slide through the drip clip. The drip clip further includes has at least one, and preferably, two integral brackets underneath the clip body to hold the spaghetti drip tubing (OD usually ranging between 0.220″ and 0.250″).

The drip clip herein described allows for the spaghetti tube to be secured near the tree or vine trunk and later moved outward as the plant grows, thereby matching the growth pattern of the roots and encouraging them to extend outward.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a highly schematic front view in elevation of an embodiment of the drip clip of the present invention;

FIG. 2 is a front left perspective view showing the drip clip of FIG. 1 installed on a smaller gauge drip wire, with distribution tubing disposed through the drip clip body and spaghetti tubing disposed in both bottom brackets of the drip clip;

FIG. 3 is a front left perspective view showing the drip clip installed on a larger gauge drip wire, with distribution tubing disposed through the drip clip body and spaghetti tubing disposed in both bottom brackets of the drip clip;

FIG. 4 is a schematic front view in elevation showing an alternative embodiment of the inventive drip clip;

FIG. 5 is a front left perspective view showing the embodiment of the drip clip of FIG. 4 installed on a smaller gauge drip wire, with distribution tubing disposed through the drip clip body and spaghetti tubing disposed in both bottom brackets of the drip clip;

FIG. 6 is a front left perspective view showing the embodiment of the drip clip of FIGS. 4-5 installed on a larger gauge drip wire, with distribution tubing disposed through the drip clip body and spaghetti tubing disposed in both bottom brackets of the drip clip;

FIG. 7 is an upper perspective view showing another embodiment of the drip clip, in this instance a pipe clip, illustrating the invention disposed in a corrugated perforated pipe and spaghetti tube clamped in the clip;

FIG. 8 is a top plan view in elevation of the clip of FIG. 7;

FIG. 9 is a cross-sectional side view in elevation taken along section line 9-9 of FIG. 7;

FIG. 10 is a top plan view of an alternative form of the embodiment of FIGS. 7-9;

FIG. 11 is a schematic front view in elevation of still another embodiment of the drip clip;

FIG. 12 is a front left perspective view showing the embodiment of the drip clip of FIG. 11 installed on a drip wire, with distribution tubing disposed through the drip clip body and spaghetti tubing disposed in both bottom bracket holes of the drip clip, and further includes a cross-sectional side view in elevation showing a perforated pipe disposed in a cylindrical hole immediately underneath the drip clip;

FIG. 13 is a schematic front view in elevation of still another embodiment of the drip clip;

FIG. 14 shows the embodiment of FIG. 13 installed on a drip wire and disposed above a bore hole;

FIG. 15 shows yet another embodiment of the drip clip, adapted for holding either a single spaghetti tube or spaghetti tubes in a stacked configuration;

FIG. 16 shows the clip of FIG. 15, disposed between a water supply pipe and installed on a drip wire above the supply pipe, this view showing micro-irrigation tubing stacked in the clip and originating from both upstream and downstream sides of the clip; and

FIG. 17 is a front perspective view showing the drip clip assembly of FIG. 5 disposed over a depression in soil, rather than over a perforated pipe.

### DETAILED DESCRIPTION OF THE INVENTION

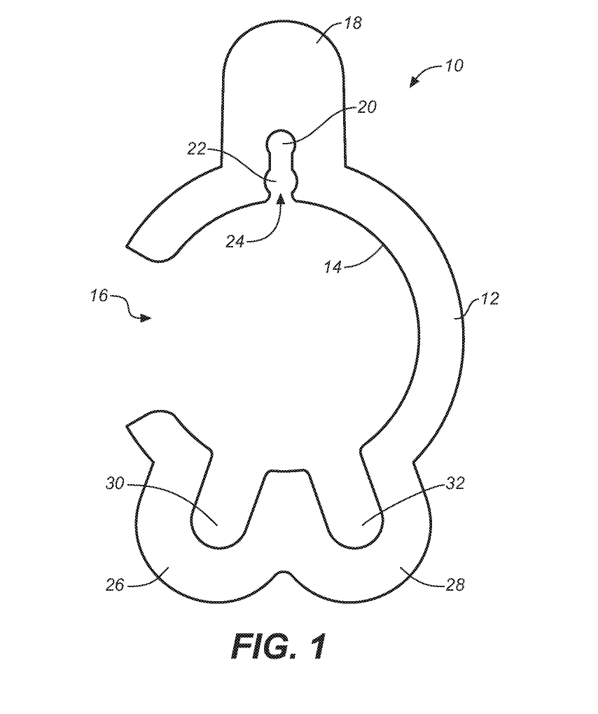

Looking first at FIG. 1, there is shown a preferred embodiment of the drip clip of the present invention, generally denominated 10 herein. The clip includes a clip body 12 having an arcuate circumferential interior side 14 and an opening 16 sized to accept a drip irrigation distribution tube in a loose fit so as to permit the tube to slide laterally with the opening defined by the arcuate side.

The top of the drip clip includes a hanger portion 18 in which an upper small wire clamp 20 is disposed, underneath which is a larger gauge wire clamp 22. The opening 24 from the clip body to the wire clamps is slightly smaller than either small or large opening, such that the hanger portion flexes slightly to accommodate the wire, but thereafter clamps firmly over the wire to hold the clamp in place on the wire after installation.

At the bottom of the clip body, at least first, but preferably first and second spaghetti tube brackets 26, 28, include at least a first, but preferably first and second U-shaped channels 30, 32, respectively, that securely hold spaghetti tube in place, such that even as the water distribution tube is allowed to migrate laterally with the clip body, the spaghetti tubing remains fixed relative to the clip body.

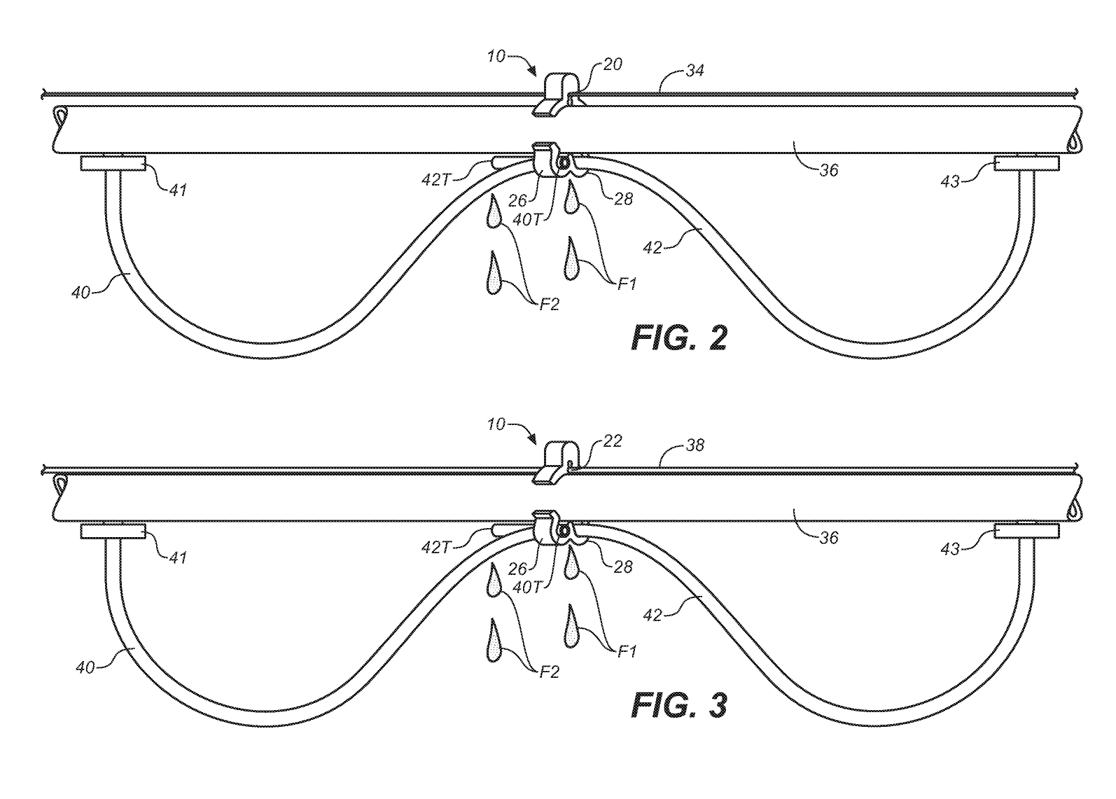

FIG. 2 shows the clip body 10 installed on a small gauge drip irrigation wire 34, such that the wire is clamped in the upper (small) wire clamp 20 of the drip clip. A water distribution tube (typically a flexible polyethylene drip tubing water supply tube or pipe) 36 is suspended below the irrigation wire by the drip clip 10, where it is loosely clamped within the arcuate interior opening. FIG. 3 shows the drip clip installed on a larger gauge wire, where it is clamped by the lower (larger) wire clamp 22. Micro-irrigation spaghetti tubing 40, 42 is coupled to flow regulating emitters 41, 43, respectively, inserted into the water supply tube and then secured in the lower spaghetti tube brackets 26, 28, and water F1, F2, is discharged from the respective terminal ends 40T, 42T.

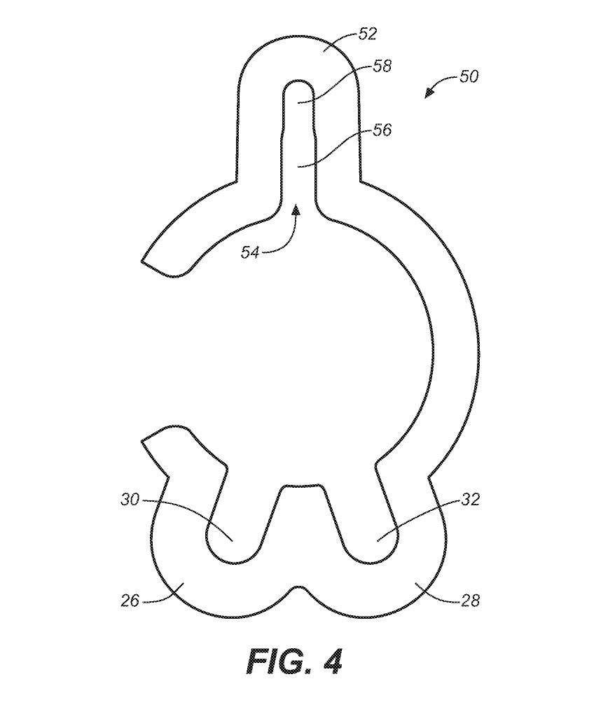

FIG. 4 shows a second preferred embodiment 50 of the drip clip of the present invention. All of the features match those of the first preferred embodiment, save for the upper wire hanger portion 52, which includes a singular and continuous U-shaped channel with a first diameter 54 for accepting and clamping larger gauge wire 60 and a second, upper, diameter 56, for accepting and clamping smaller gauge wire 62.

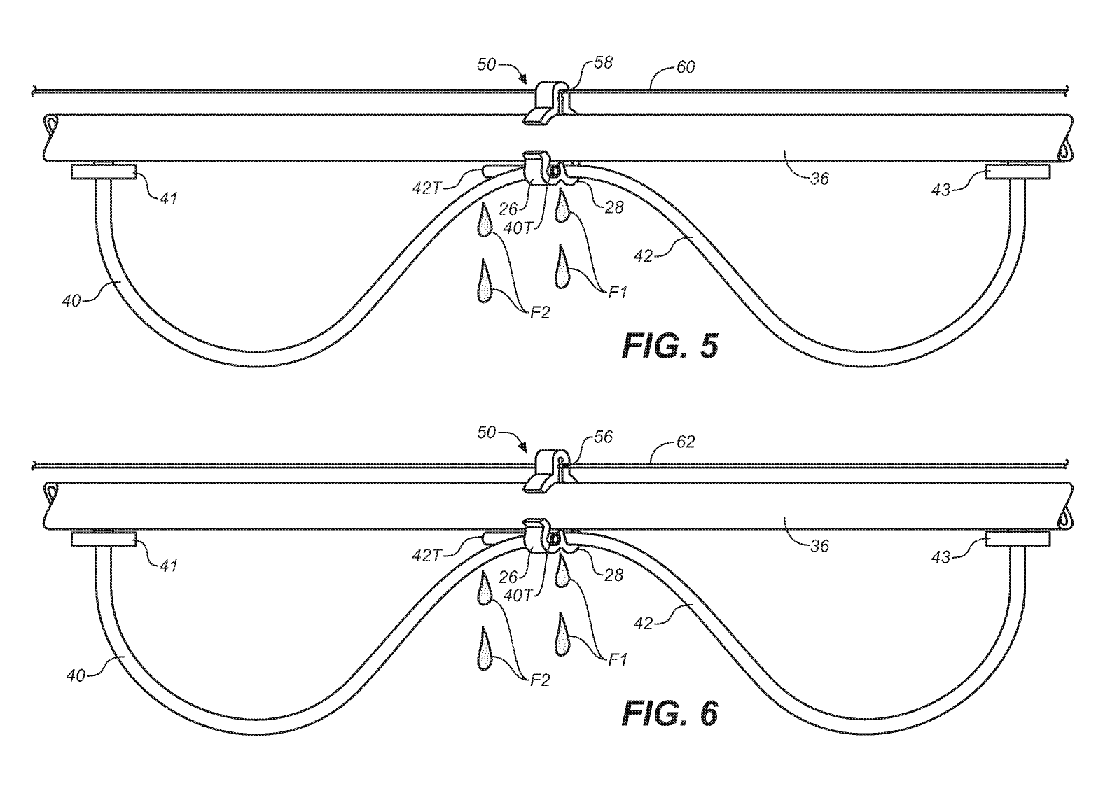

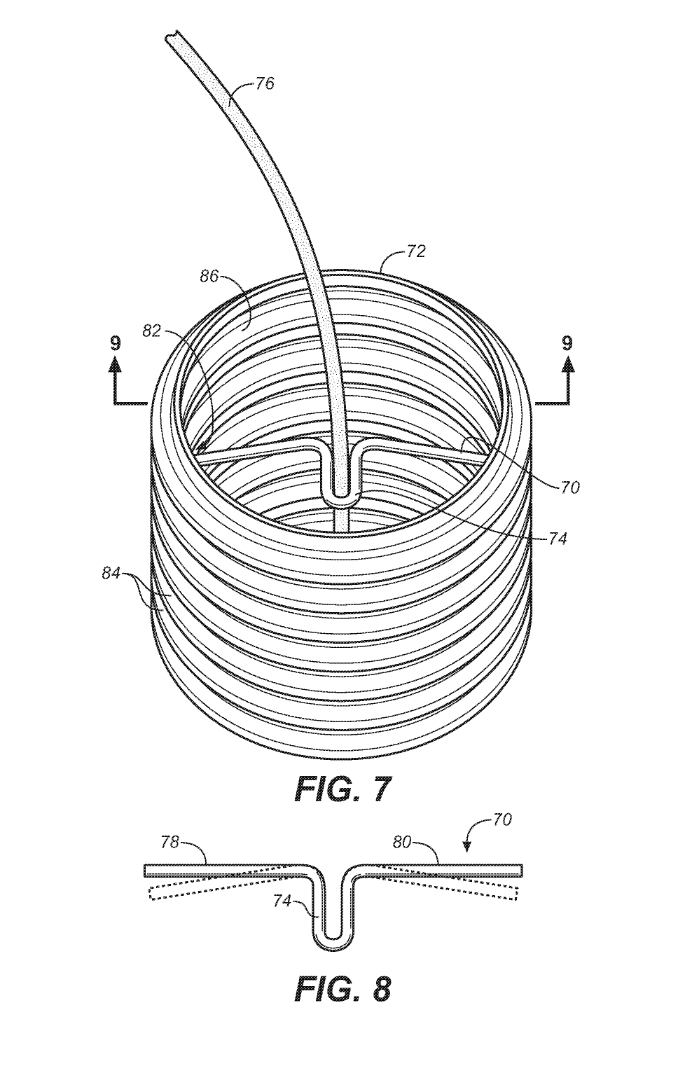

FIG. 5 shows the second embodiment of the clip body 50 installed on a small gauge drip irrigation wire 60, such that the wire is clamped in the upper (smaller) diameter portion 58 of the drip clip. A water distribution tube 36 is suspended below the irrigation wire by the drip clip 50, where it is loosely clamped within the arcuate interior opening. FIG. 6 shows the drip clip 50 installed on a larger gauge wire 62, where it is clamped by the lower (larger) wire diameter portion 56. Again, spaghetti tubing 40, 42 is coupled to flow regulating emitters 41, 43 in the water supply tube, and then secured in the lower spaghetti tube brackets 26, 28, and water F1, F2, is discharged from the respective terminal ends 40T, 42T.

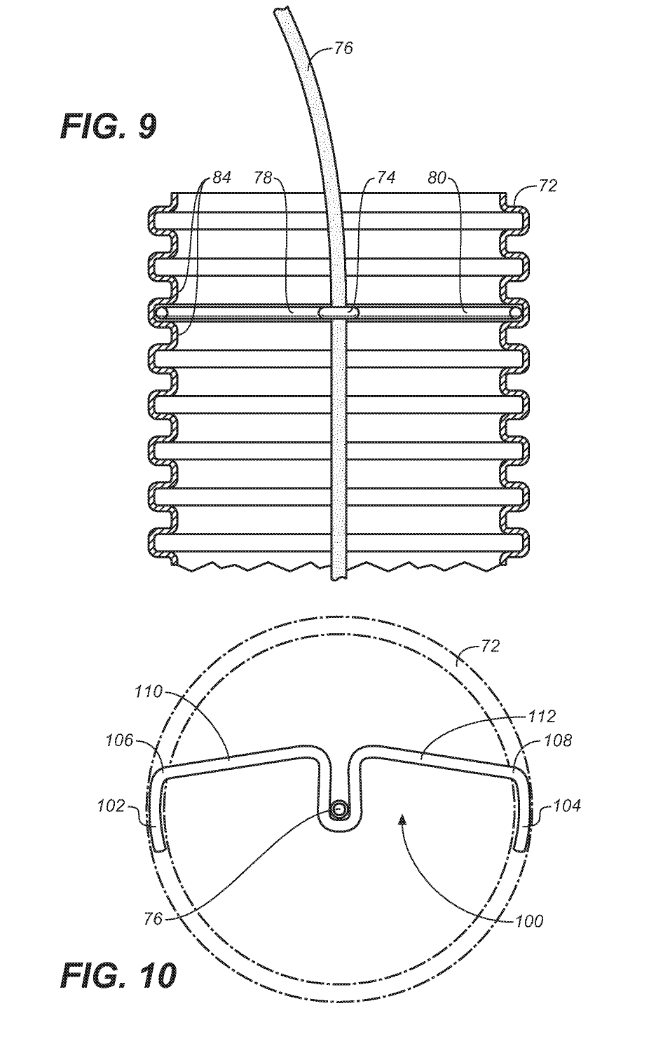

FIGS. 7-9 show an alternative embodiment 70 of the clip of the present invention, in this instance adapted for installation on the interior of a corrugated perforation pipe 72. The clip includes a U-shaped wire portion 74 sized to clamp spaghetti tubing 76 securely while not restricting water flow through the tube. Extending outwardly from the top of the U-shaped wire portion are integral wire arms 78, 80 which flex to permit placement in the trough portion 82 between crests of corrugation ridges 84 on the pipe interior 86.

FIG. 10 shows a slight variation 100 on the design of FIGS. 7-9, the only material difference being the inclusion of arcuate fingers 102, 104 at the terminal portions 106, 108 of arms 110, 112.

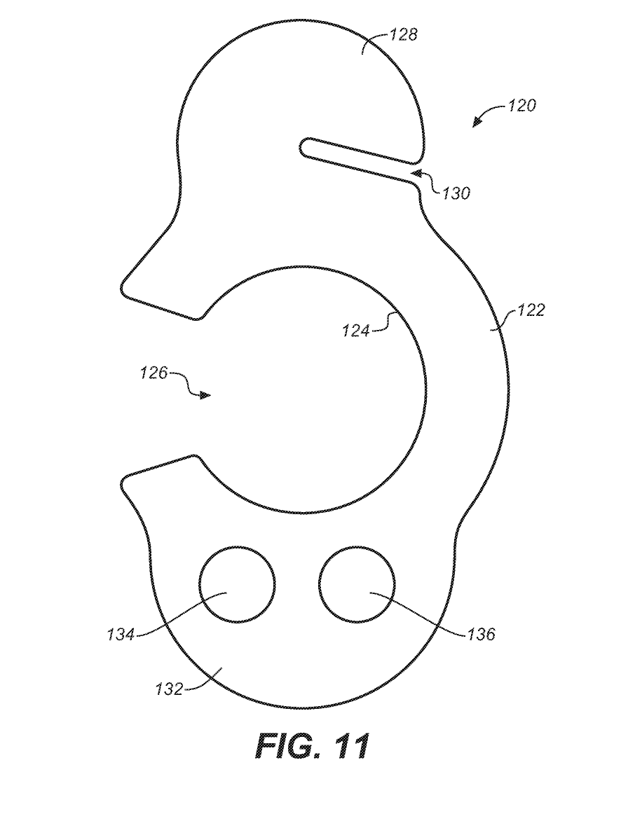

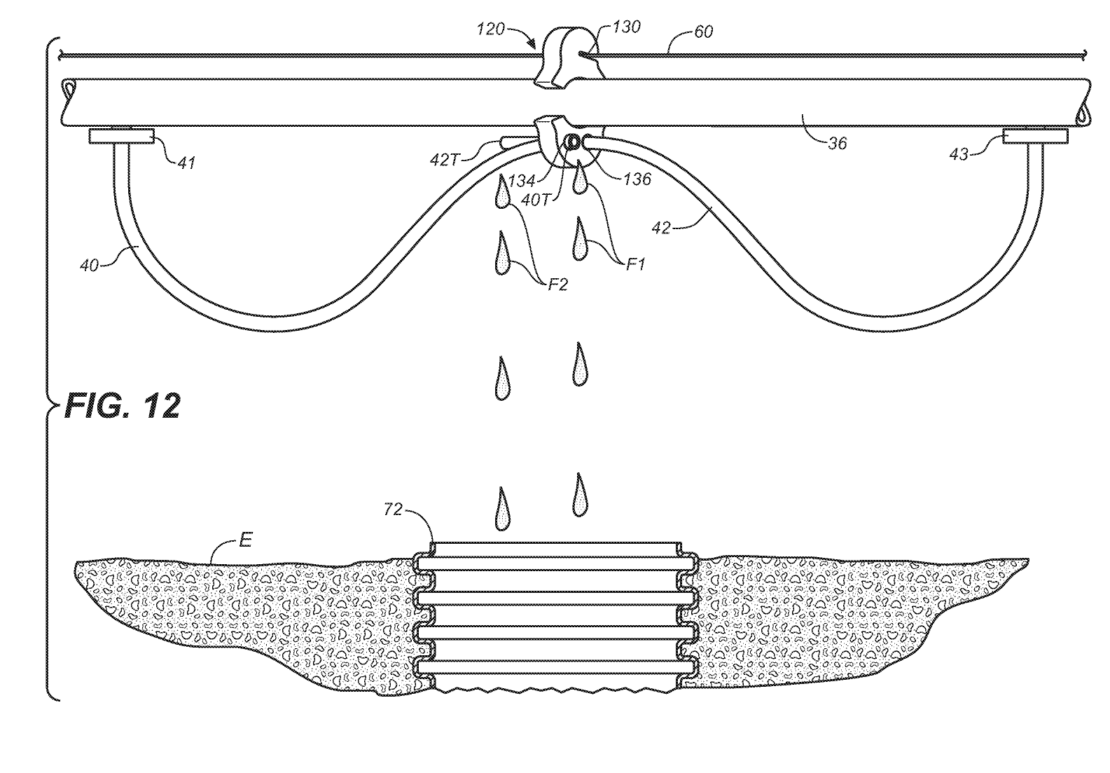

FIGS. 11-12 show another embodiment 120 of the inventive drip clip, which includes a clip body 122 having an arcuate circumferential interior side 124 and an opening 126, and as before, sized to accept a drip irrigation distribution tube in a loose fit so as to permit the tube to slide laterally with the opening defined by the arcuate interior side.

The top of the drip clip includes a hanger portion 128 in which a diagonally disposed wire clamp slip 130 is disposed. The bottom portion 132 of the clip body includes, first and second spaghetti tube holes 134, 136, which securely hold spaghetti tubing in place, in the manner of the first and second preferred embodiments, 10, and 50, respectively, such that even as the water distribution tube is allowed to migrate laterally with the clip body, the spaghetti tubing 40, 42 remains fixed relative to the clip body, and further such that water F1, F2, discharged from the respective spaghetti tubing terminal ends 40T, 42T will continue to be directed immediately over the corrugated pipe.

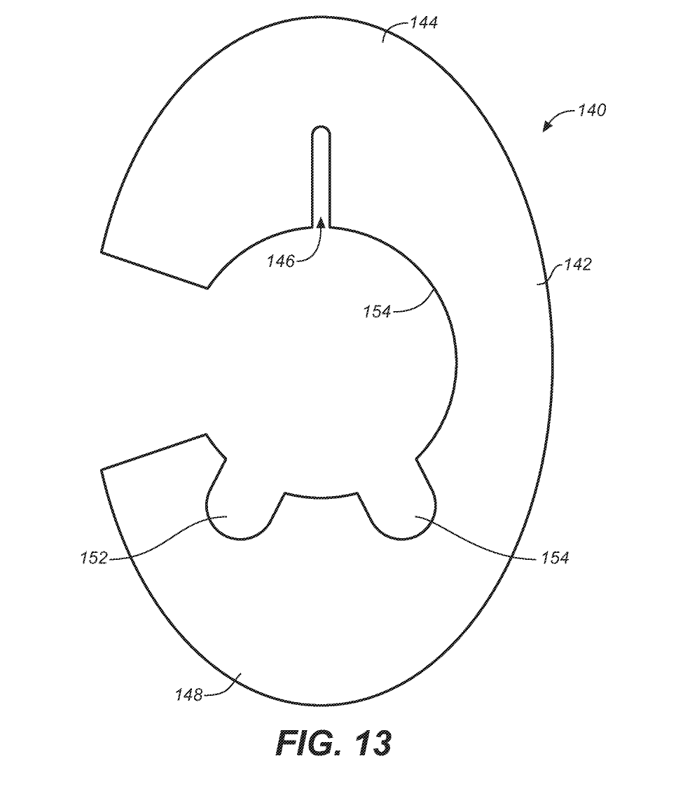

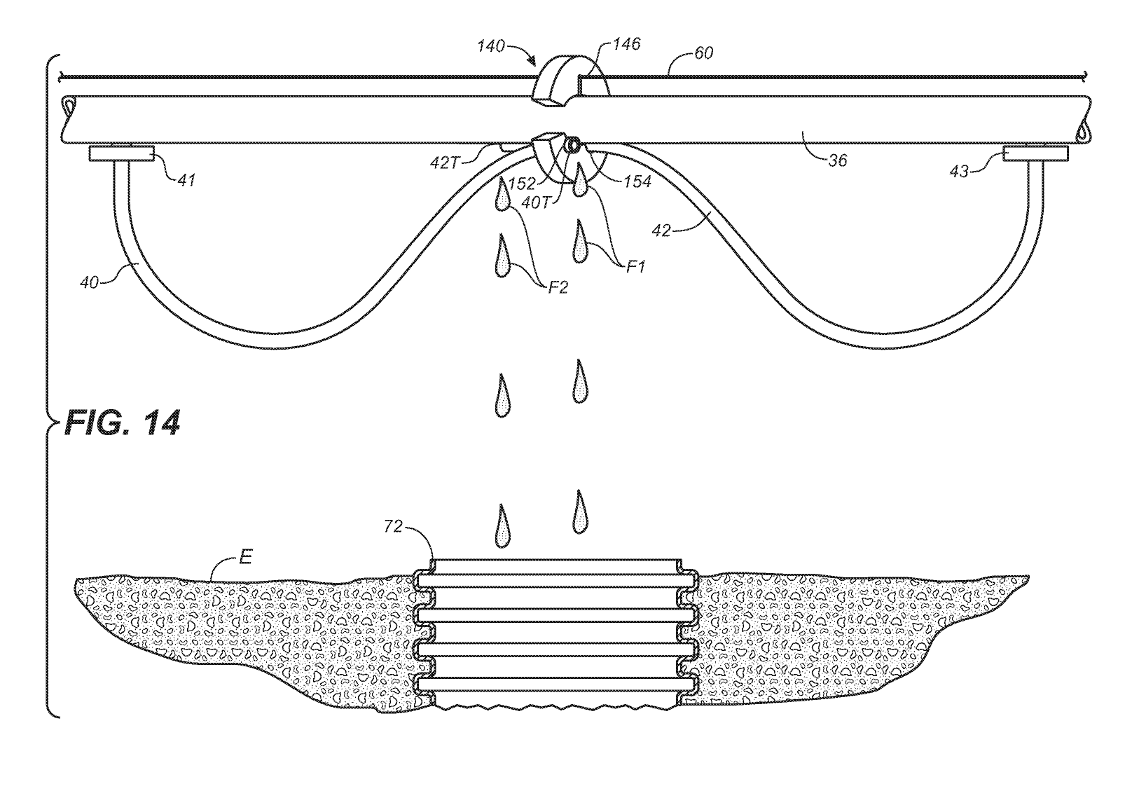

FIGS. 13-14 show yet another embodiment 140, this having a generally oval-shaped clip body 142 with an upper portion 144 having a wire slot 146 and a lower portion 148 having first and second spaghetti tube clamps 150, 152. Again, the clip body includes an arcuate interior side 154 that loosely accommodates a distribution water tube.

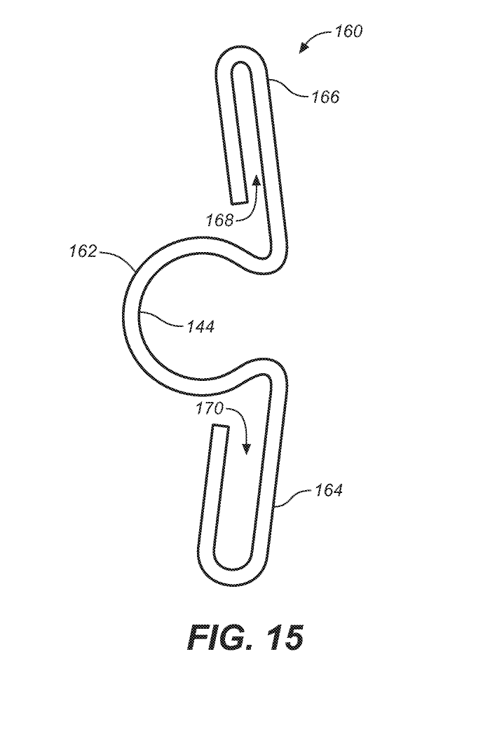

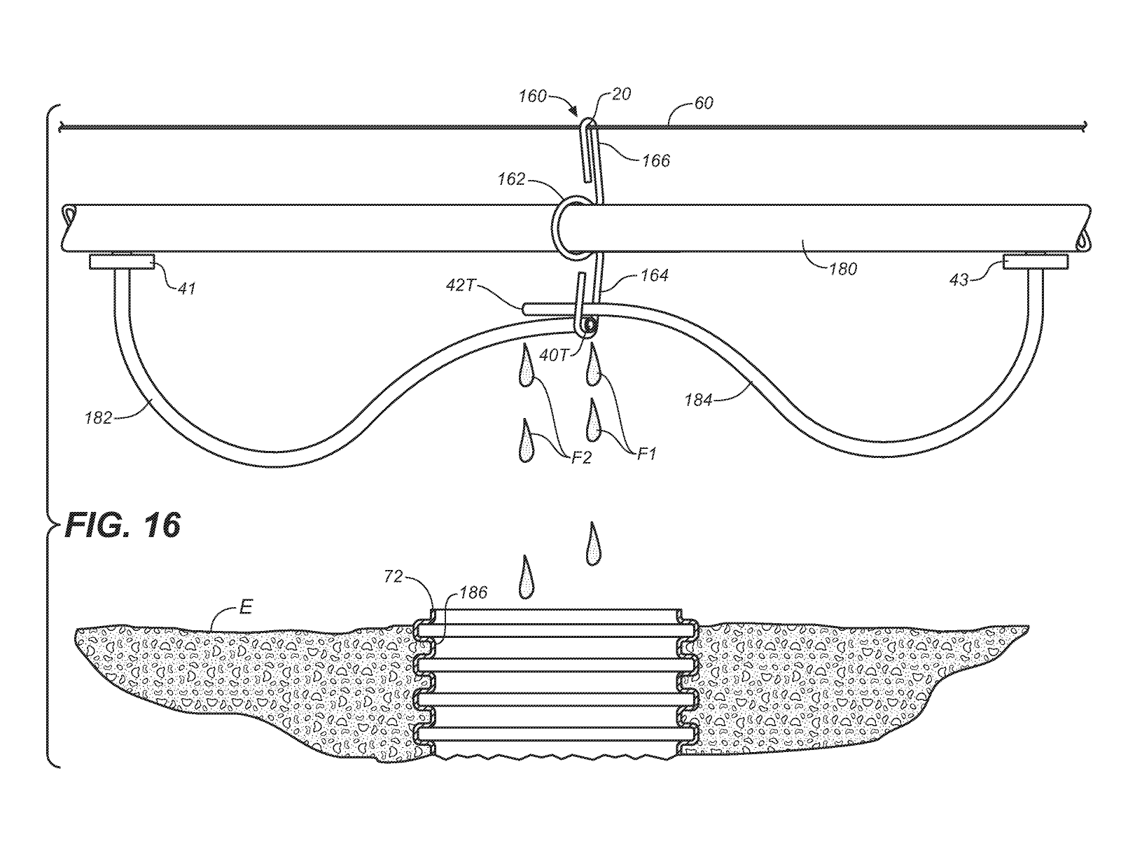

FIGS. 15-16 show the inventive drip clip hanger concept realized in a wire embodiment 160. The continuous wire includes an arcuate medial body portion 162 with an interior circumferential clamping portion 164 for loosely securing a water distribution tube 180, an upper wire clamp portion 166 with a U-shaped wire clamp slot 168, and a lower spaghetti tube clamp portion 170 with a U-shaped channel 172 for securely clamping spaghetti tubes 182 and 184. The clip, when installed on water supply tubing 180 is positioned so as to bring the water outlet portions (i.e., the terminal ends) 40T, 42T of the spaghetti tubes over a perforated pipe 72 vertically disposed in the ground E. The spaghetti tubes are again coupled to flow regulating emitters installed in the water supply pipe.

As will be appreciated, this wire embodiment is disposed between a water supply pipe (the water distribution tube 180) is installed on and under a drip wire above the supply pipe, such that the supply pipe is also supported by the wire. In this view it can be seen that two the micro-irrigation tubes are stacked in the clamping portion 164 of the clip, one originating from a point in the supply tube upstream of the clip and the other originating from a point in the supply tube downstream of the clip.

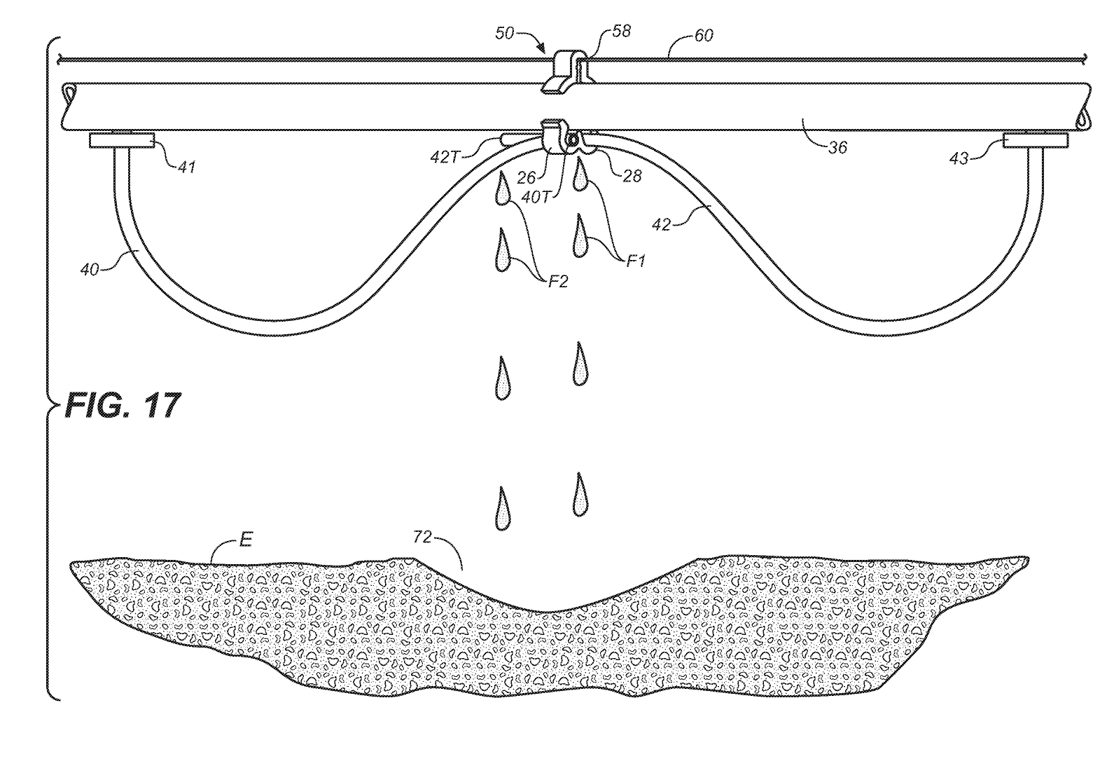

It will also be appreciated, and referring now to FIG. 17, that use of the perforated pipe, as shown in FIGS. 12, 14, and 16, is not an essential element for practicing above-ground micro-irrigation using the apparatus described herein. Rather, a simple depression 73 in the soil may be formed to collect and focus water distribution in the soil at the root region of the plant.

Further, and as will be appreciated with respect to each of the above-described embodiments, positioning of the water outlets (micro-irrigation tube terminal ends) 40T, 42T, involves nothing more than sliding the clip and the captured terminal ends laterally along the length of the water supply tube and the hanger wire 60. Moreover, the terminal ends of the spaghetti tubing may be spaced at increasing distances to expand the area covered by the dripping water, or they may be positioned over an area uphill from the plant trunk (or rootstock) or its main stem. This enables a grower to fine tune watering to the edges of root zones as plants mature, to encourage full root development, prevent overwatering in less active root regions, and thereby to conserve water and promote optimal plant health. In circumstances where regular lateral movement of the terminal ends is anticipated as dictated by root development, elimination of the perforated pipe both assures broader water migration nearer the surface of the soil and obviates the need to dig new holes for installation of the perforated pipe.

From the foregoing, it will be seen that in its most essential aspect, the above-described apparatus comprises a bracket for hanging drip irrigation system water supply tubing and micro-tubing. The bracket attaches firmly to a drip irrigation system suspension wire, and supports and suspends both a water supply tube and micro-irrigation tubing fed by the water supply tube. The bracket (or hanger) includes one or more apertures or channels to support the spaghetti tubing below the water supply tubing and to hold the terminal ends (or water outlets) above the soil region to be irrigated. The water is dispensed in a vertical plane on either side of the bracket, and the zone covered by the dripping water may be adjusted according to plant needs by directing the terminal ends outwardly in any direction from the bracket.

Stated slightly differently, in its most essential aspect, the drip clip of the present invention is a bracket for hanging drip irrigation system water supply tubing and micro-tubing, comprising a wire hanger portion for attachment to a drip irrigation system suspension wire; a micro-irrigation tube hanging portion adapted for releasably capturing and securing micro-irrigation tubing in fluid communication; and a water supply tube portion disposed between said wire hanger portion and said micro-irrigation tube hanging portion, said water supply tube portion for releasably and slidingly clamping onto a drip irrigation water supply tube.

Numerous materials and manufacturing processes are suitable for the drip clip described herein, from simple wire bending for the wire embodiments (FIGS. 15-16), to plastic injection molding and/or machining for the solid and preferably monolithic embodiments of FIGS. 1-6 and FIGS. 11-14.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A bracket for hanging drip irrigation system water supply tubing and micro-tubing, comprising:
a wire hanger portion for attachment to a drip irrigation system suspension wire;
a micro-irrigation tube hanging portion adapted for releasably capturing and securing micro-irrigation tubing in fluid communication; and
a water supply tube portion disposed between said wire hanger portion and said micro-irrigation tube hanging portion, said water supply tube portion sized for releasably and slidingly clamping onto a drip irrigation water supply tube.

2. The bracket of claim 1, wherein said bracket is integrally formed as a monolithic block to include a clip body having an arcuate circumferential interior side and an opening sized to accept a drip irrigation water supply tube; a hanger portion formed in a top side of the bracket;
and at least one micro-irrigation tube bracket disposed at the bottom of said clip body to securely hold the micro-irrigation tubing proximate a terminal end, such that even as the water supply tube is allowed to migrate laterally within the clip body, the micro-irrigation tubing remains fixed relative to said clip body.

3. The bracket of claim 2, wherein said arcuate circumferential interior side is sized so as to permit the water supply tube to slide laterally within the opening defined by the arcuate side.

4. The bracket of claim 3, wherein said arcuate circumferential interior side is sized with a diameter ranging approximately between 0.620″ to 0.710″.

5. The bracket of claim 3, wherein said hanger portion flexes to accommodate a drip suspension wire.

6. The bracket of claim 2, wherein said hanger portion flexes to accommodate a drip suspension wire

7. The bracket of claim 2, wherein said at least one micro-irrigation tube bracket is shaped to secure micro-irrigation tubing.

8. The bracket of claim 7, wherein said at least one micro-irrigation tube bracket is a U-shaped channel and accommodates at least two micro-irrigation tubes in either a stacked or side-by-side configuration.

9. The bracket of claim 8, wherein said at least one micro-irrigation tube bracket is sized to slidably capture micro-irrigation tubing.

10. The bracket of claim 9, wherein said at least one micro-irrigation tube bracket includes an opening having a diameter between 0.220″ and 0.250″.

11. The bracket of claim 2, wherein said at least one micro-irrigation tube bracket includes a plurality of U-shaped channels in a side-by-side relationship.

12. The bracket of claim 11, wherein said at least one micro-irrigation tube bracket is sized to slidably capture micro-irrigation tubing.

13. The bracket of claim 1, wherein said wire hanger portion includes two annular portions differentially sized to accommodate and tightly capture in a friction fit suspension wire of two differing gauges.

14. The bracket of claim 1, wherein said bracket is fabricated from a continuous bent wire, wherein said wire hanger portion is a U-shaped wire-clamping portion, said water supply tube portion is an arcuate length of wire defining an opening, and said micro-irrigation tube hanging portion is a U-shaped channel having an opening smaller than said opening in said water supply tube portion.

15. The bracket of claim 1, wherein said wire hanger portion includes a wire clamp slot cut diagonally into said wire hanger portion.

16. The bracket of claim 15, wherein said micro-irrigation tube bracket portion includes at least one hole through said micro-irrigation tube bracket portion.

17. The bracket of claim 1, wherein said bracket is integrally formed as a monolithic block to include an oval shaped clip body with an upper portion having a wire slot and a lower portion having first and second micro-irrigation tube clamps, and an arcuate interior side disposed therebetween.
